(19) United States
(12) Patent Application Publication
(10) Pub. No.: US 2006/0088633 A1
(43) Pub. Date: Apr. 27, 2006

(54) Process to produce a reduced fat potato chip

(76) Inventors: Keith Alan Barber, Frisco, TX (US); David Lawrence Barry, Highland Village, TX (US); Kelly Sam Miller, The Colony, TX (US); Donald Vaughn Neel, Highland Village, TX (US); Myron Edward Silver, Highland Village, TX (US); Tawnya Lynn Turley Smart, Plano, TX (US); James William Stalder, Dallas, TX (US)

Correspondence Address: CARSTENS & CAHOON, LLP, P O BOX 802334, DALLAS, TX, 75380, US

(21) Appl. No.: 10/973,567

(22) Filed: Oct. 26, 2004

(51) Int. Cl. A23B 4/044; A23B 4/03

(52) U.S. Cl. 426/465

(57) ABSTRACT

A novel improved process and apparatus is disclosed for producing low oil potato chip products having less than 30 percent by weight oil based on the total weight of an unseasoned chip. The process requires contacting the chip with a brine solution, frying the chip, and concurrently dehydrating and de-oiling the chip with superheated steam in a single unit operation.

### BACKGROUND OF THE INVENTION

1. Technical Field

The present invention relates to an improved method for producing a low oil content potato chip. More specifically, the present invention relates to a method whereby moisture content and oil content are controlled in a unique combination of unit operations.

2. Description of Related Art

Conventional potato chip products are prepared by the basic steps of slicing peeled, raw potatoes, water washing the slices to remove surface starch and frying the potato slices in hot oil until a moisture content of about 1% to 2% by weight is achieved. The fried slices are then salted or seasoned and packaged.

Raw potato slices normally have moisture contents from 75% to 85% by weight depending on the type of potato and the environmental growing conditions. When potato slices are fried in hot oil, the moisture present boils. This results in burst cell walls and the formation of holes and voids which allow for oil absorption into the potato slices yielding oil contents ranging from 30% to 45% by weight.

The oil content of potato chips is important for many reasons. Most important is its contribution to the overall organoleptic desirability of potato chips, however from the standpoint of good nutrition, it is desirable to maintain a low level of oil or fat in chips. Further, a high oil content renders the chips greasy or oily and hence less desirable to consumers. On the other hand, it is possible to make chips so low in oil that they lack flavor and seem harsh in texture. A happy medium can be achieved by reducing the oil content in a chip so that the objectives of using less oil is met and consumers interested in reducing their intake of both fats and calories can be satisfied with an organoleptically pleasing snack food.

Numerous attempts have been made in the prior art to reduce the oil content in potato chips. Some attempts involve pre-treating the potato slices prior to frying. Other attempts involve treating the chips after frying, and some attempts use both pre- and post-treatments. However, past attempts at producing lower oil content chips are either expensive, or have failed to maintain the desired organoleptical properties such as taste and texture that have become familiar to consumers of traditional potato chips having higher fat or oil contents.

For example, U.S. Pat. No. 4,749,579 teaches a process for producing potato chips having a fat content lower than 32% by weight. The '579 Patent discloses a pre-treatment process whereby potato slices are washed in a salt solution. The potato slices are dried and potato slices are pre-heated with infrared radiation prior to being sent to the fryer. This process however, discloses a maximum reduction of oil content of about 32%, by disclosing a potato chip having a fat content of 26% to 32% by weight compared with a prior art oil content of 38%. It is desirable, however, to reduce oil contents by at least a third. Further, the '579 Patent fails to disclose a finished product moisture content or a means to control the moisture content independent of oil content.

Another prior art attempt for making a low oil potato chip by pre-fry treatment is disclosed by U.S. Pat. No. 4,917,919, which teaches coating a potato chip with an aqueous, polyvinylpyrrolidone. Unfortunately, the moisture content of the finished product is about 4% by weight, raising concerns of shelf stability.

U.S. Pat. No. 4,933,199, assigned to the same Assignee as the present invention, involves treating a fried potato chip in a de-oiling unit to lower the oil content of the chip and further treating the chip in a dehydrating unit to lower the moisture content of the chip. Unfortunately, each unit operation adds substantial capital costs as well as operating cost to the process. Further, the '199 Patent indicates that attempting to de-oil potato slices to produce low oil potato chips and simultaneously arrive at a desired final moisture content has been found to be difficult to achieve in the same unit. The '199 Patent indicates that optimized de-oiling and optimized final moisture content are not arrived at simultaneously.

Similarly, U.S. Pat. No. 4,721,625 uses a post-fry saturated steam treatment to reduce the oil content of the potato slices. A saturated steam blasting process, however, generally results in a pick up of moisture by the cooked slices due to condensation. As a result, the cooked slices require a subsequent drying unit operation. As previously indicated, this subsequent drying operation involves substantial economic capital and operating outlays.

Another prior art solution to making a low oil potato chip is illustrated by U.S. Pat. No. 4,537,786, also assigned to the same Assignee as the present invention. The '786 Patent teaches that thicker than normal slicing can reduce oil uptake during frying. The '786 Patent process discloses: frying potato slices in oil at a lower than normal temperature of between about 280° F. and 320° F., removing the potato slices from the fryer when the moisture content is about 3% to about 15% by weight, orienting the potato slices on edge, and contacting the fried potato slices for about 1 to about 10 minutes with a stream of hot air. This hot air removes the excess oil as well as finishes cooking the chip. However, hot air tends to accelerate oxidation of the oil reducing shelf life dramatically.

Another prior art solution for a low oil potato chip is disclosed in U.S. Pat. No. 4,277,510, a process for making low oil potato chips by drying the slices in a monolayer, contacting the resultant dried potato slices with steam, and frying the steam-treated potato slices. Unfortunately, according to U.S. Pat. No.4,721,625 (discussed above), the pre-drying of the product in the '510 Patent results in a glassy texture, case hardened product that has a raw, green flavor, which is different in taste and texture from regularly fried potato chips.

Accordingly, a need exists to provide an economical method and apparatus for making reduced oil potato chips having desirable organoleptical properties similar to traditional potato chips.

### SUMMARY OF THE INVENTION

The proposed invention provides an apparatus and method for making reduced oil potato chips. In one embodiment, a combination of potato slice thickness and slice pre-treatment in a salt brine solution prior to being fried to a moisture level of about 3% to about 8% allows the manufacture of potato chips that are both lower in oil and dried to a stable, controllable moisture content in a single post-fry unit operation. Hence, the present invention provides a more economical apparatus and method for making a low oil potato chip having desirable organoleptical properties. The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective schematic representation of one embodiment of an apparatus that can be used to practice the method of this invention, which includes a slicer, slice pretreatment, a continuous fryer, and a single de-oiling/dehydrating unit.

### DETAILED DESCRIPTION

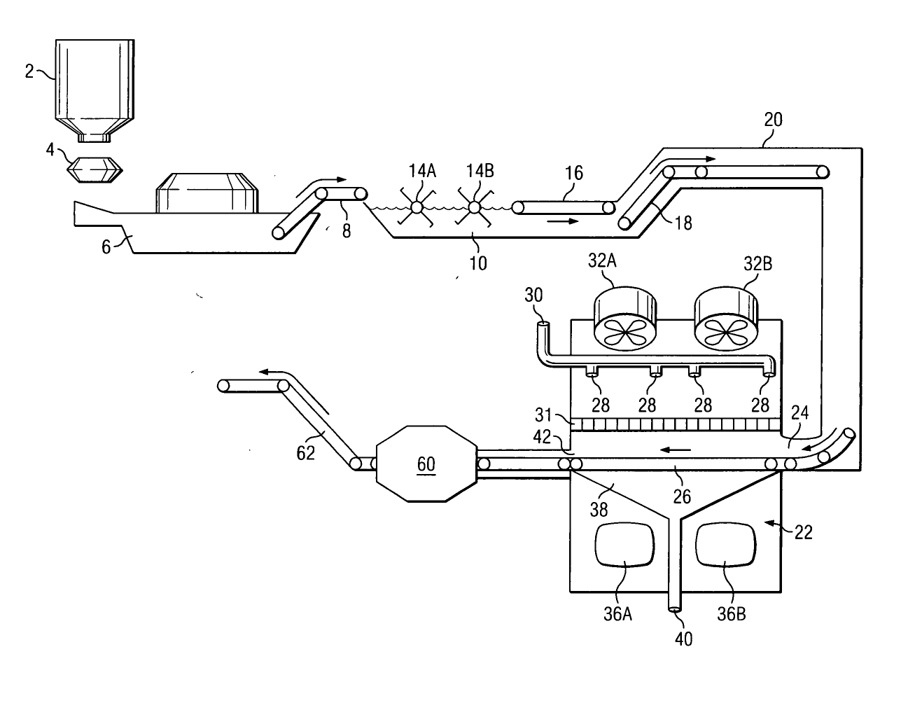

An embodiment of the innovative invention will now be described with reference to FIG. 1. Whole potatoes stored in hopper 2 are dispensed into a slicing apparatus 4 which drops potato slices into a water wash 6. In one embodiment, the potatoes are sliced to a thickness of between about 0.050 inches and about 0.083 inches in the slicer 4. Interestingly, by changing slice thickness from 0.053 inches to 0.068 inches, the oil content of the finished chip product can be lowered by about 9%. Thicker slices result in even higher oil reductions. However, organoleptical properties can be compromised because the chip becomes softer and more mealy as slice thickness increases. An advantage of using thicker slices is that it achieves oil reduction without incurring any extra capital cost. The potato slices can be cut into a cut geometry including, but not limited to, a substantially flat geometry, a substantially ridged geometry, or a substantially wavy geometry.

The potato slices can next be routed to a water wash 6 where the potato slices are contacted with a brine solution. In one embodiment, the water wash 6 comprises a brine solution containing between about 1% to about 6% of salt (NaCl) and more preferably between about 1.0% to about 4.5%. Brine solutions above 6% tend to result in very salty flavors. It has been found that a residence time of between about 2 seconds and about 20 seconds, and more preferably about 6 seconds in a brine solution is sufficient for the potato slices of this invention. In one embodiment, the water wash 6 comprises a process volume enabling the brine solution to have full surface contact with the potato slices. The slices are removed from the water wash 6 by an endless belt conveyor 8 and deposited in frying oil contained within a fryer 10.

In an alternative embodiment, the water wash 6 does not contain a brine solution and a brine solution is sprayed on the potato slices after exiting the water wash 6 while on a conveyor belt 8. In one embodiment, the potato slices, after a brineless water wash, enter a brine solution before being routed to the fryer 10. The endless belt conveyor 8 can be designed as a drain conveyor to allow excess wash water or brine to drain from the slices. In one embodiment, an air knife (not shown) can be mounted above the endless belt conveyor 8 and a vacuum suction device (not shown) can be mounted underneath the endless belt conveyor 8 to aid in removal of excess moisture. The frying oil entering the fryer is maintained at an initial temperature between about 320° F. to about 380° F. more preferably between about 340° F. and about 365° F. In one embodiment, the fryer is a continuous single flow or multizone fryer which utilizes devices such as paddle wheels, 14A and 14B, and a submergible conveyor belt 16 to control the flow of potato slices through the fryer 10. Once the potato slices have been cooked to a water content of between about 3% to about 8% by weight, the slices are removed from the fryer by an endless belt conveyor 18. In one embodiment, the frying oil in the vicinity of the endless belt conveyor 18 comprises a final temperature of between about 280° F. to about 340° F. If the slices are cooked to lower water content levels, it will be difficult to achieve the desired oil removal without scorching the slices. If the potato slices exceed a moisture content of 8% by weight, it will be difficult to achieve the desired moisture and oil levels simultaneously without scorching the slices. Scorched slices result in undesirable off-flavors.

The endless belt conveyor 18 is used to route the potato slices to the de-oiling unit 22. Because the potato slice is removed from the oil before it is fully fried, it is referred to as a parfried potato slice. In one embodiment, the slices after par-frying comprise an oil content of between about 24% and about 34% by weight. A 0.068 inch thick potato slice contacted with a 3% brine solution had an oil content of about 27.5% upon exiting the fryer 10, with a moisture content of about 4.78%. By comparison, an unbrined 0.068 inch potato slice had an oil content of about 31% upon exiting the fryer at a higher moisture content of about 6%. It should be noted that using potato slices from potatoes having a high solids content, also reduces the oil absorption in the fryer. As shown in the Figure, the pathway utilized by endless belt conveyor 18 can be covered by a housing 20 to prevent loss of sensible heat from the par-fried slices and to reduce the exposure of the par-fried oil contained therein to oxidative conditions.

It has been surprisingly found that by using a combination of slice thickness and pre-treatment with a salt brine solution, that a single post-fryer unit operation is needed to both dehydrate and de-oil the potato slices to desired levels after frying. Without pre-treating potato slices it has proven difficult to obtain the desired finished moisture and oil contents simultaneously without over drying and scorching the finished product.

The par-fried slices enter a de-oiling/dehydrating unit 22 through opening 24 and pass through the unit on a porous endless belt conveyor 26. In the embodiment shown in this figure, de-oiling/dehydrating is concurrently accomplished by injecting superheated steam through openings 28 and steam delivery means 30 to a headspace above the endless conveyor belt 26. Re-circulating blower fans 32A and 32B are shown in the space above the conveyor belt 26. The blowers generate a downward superheated steam velocity against the bed of par-fried potato slices traveling through the de-oiling/dehydrating unit 22. Re-circulated steam combines with the injected steam and is passed over heating means 31 forming superheated steam which impinges on the par-fried potato slices and strips oil and moisture. In one embodiment, steam is superheated to a temperature of about 300° F. to about 340° F. In one embodiment, the residence time of the potato slices in the de-oiling/dehydrating unit 22 is between about 30 and about 120 seconds. The steam atmosphere also purges air (oxygen) from the chamber protecting the oil both in the product as well as that removed from the product. In one embodiment, the atmosphere in the de-oiling/dehydrating unit 22 comprises an oxygen content between about 1% and about 3%. Control over the de-oiling and de-hydration processes can be modulated by adjusting the speed of the blower fans which re-circulate the superheated steam, the temperature of the superheated steam and the dwell time in the chamber.

Stripped oil is separated and collected by accumulator means 38 and removed through port 40 for recycling into fryer 10 by means not shown in the figure. The stripped oil may also go through additional clean up and re-generation equipment prior to return to the fryer 10. Re-circulation conduits below the conveyor belt 26 identified as 36A and 36B shown connected to blowers 32A and 32B, respectively, by means not shown in the figure return clean, and de-oiled steam to the blower means 32A and 32B above.

The par-fried, de-oiled, and dehydrated potato slices exit the de-oiler/dehydrating unit 22 with a moisture content of generally between about 0.8 and 2.0 weight percent. Further, the de-oiled potato slices exit the unit 22 with an oil content of between about 23% and about 30% and more preferably between about 23% to about 26%. The de-oiled and dehydrated potato chips exit the de-oiler/dehydrating unit 22 through opening 42 and advance into a tumbler 60 wherein salt and/or seasonings may be added to the potato chips. The seasoned potato chips exit the tumbler 60 on a conveyor belt 62 and are transferred to a packaging area not shown in the figure where the products are prepared for shipment.

Hence, the present invention is able to reduce the oil content of sliced potato chips by 33% to 40% without sacrificing the organoleptical properties in a much more economical manner. For example, increasing the slice thickness does not add any capital cost to the present invention. Moreover, the addition of salt to an existing water wash 6 to make a brine solution also does not substantially impact cost. Further, adding salt at the water wash 6 further reduces the amount of salt required at the tumbler 60. In addition, it has been found that the present invention results not only in elimination of a dehydrating unit but also allows for a de-oiling unit having a lesser overall duty requirement for the same amount of product than the prior art de-oiling unit. This results in not only less capital costs but also less operating costs. Hence, less steam is required in the de-oiler/dehydrating unit, less heating is required to superheat the steam, a reduced fan speed is required, and fewer fans are required. Further, elimination of the dehydration unit results in additional savings related to a smaller building size required to house the equipment and less process control equipment.

### EXAMPLES

The following examples are provided to more fully illustrate the invention and are not intended to be limitative thereof.

Several variations of the low-oil finished products were made and used in consumer testing for evaluation of organoleptical properties. Six attributes of acceptability were rated on a nine point Likert scale. A response of nine indicating that a consumer liked the particular quality being evaluated extremely; a response of eight indicates that the consumer liked the quality being evaluated very much; seven indicating the consumer liked it moderately; six indicating the consumer liked the quality slightly; five indicating that the consumer neither liked nor disliked the quality; four indicating that the consumer disliked the quality slightly; three indicating that the consumer disliked if moderately; two indicating that the consumer disliked it very much; and one indicating that the consumer disliked the quality being evaluated extremely. The superscripts indicate the level of significance between the samples. For example, the highest scores are given an “a” the next statistical grouping is given a “b” etc. Results with the same letter are not significantly different at the 90% confidence level.

Other food quality properties were evaluated using a five point Likert scale, including color, hardness, thickness, and salt intensity. As to color, a consumer response of one or two meant the product was too light; a response of three meant that the product was just right, and a response of four or five meant the product was too dark. With respect to hardness, a response of one or two meant the product was too soft, a response of three meant the product was just right, and a response of four or five meant the product was too hard. With regard to thickness, a response of one or two meant the product was too thin, a response of three meant the product was just right, and a response of four to five meant the product was too thick. With regard to salt intensity, a response of one to two indicated there was too little salt, a response of three indicated there was just the right amount of salt, and a response of four to five indicated the salt intensity was too strong.

Additionally, on a scale of one to five consumers were asked based upon their overall evaluation, their propensity to purchase the tested product. Again, a five point Likert scale was used wherein a response of five indicating that they definitely would purchase the product, a response of three indicating they might purchase the product, and a response of one indicating they definitely would not purchase the product. As a control, potato chips fried to a moisture content of 1.5% and undergoing no pre-treatments or de-oiling were used. The control sample had an oil content of 38% by weight.

Samples 1-9 were produced in an apparatus similar to one shown as FIG. 2 in U.S. Pat. No. 4,933,199 with a major difference being the omission of the dehydrating unit 44, which corresponds to FIG. 1 of the present application. The results of the tests are shown in Table 1 below:

TABLE 1

| | Control | Sample 1 | Sample 2 | Sample 3 | Sample 4 | Sample 5 | Sample 6 | Sample 7 | Sample 8 | Sample 9 |
|---|---|---|---|---|---|---|---|---|---|---|
| PROCESS CONDITIONS | | | | | | | | | | |
| SLICE THICKNESS, | 0.053 | 0.068 | 0.068 | 0.068 | 0.068 | 0.068 | 0.068 | 0.058 | 0.058 | 0.058 |
| INCHES | | | | | | | | | | |
| BRINE, % | 0 | 0 | 0 | 0 | 3 | 3 | 3 | 3 | 3 | 3 |
| FAN SPEED | 0 | 20 | 50 | 90 | 50 | 90 | 20 | 20 | 50 | 90 |
| ANALYTICALS | | | | | | | | | | |
| MOISTURE, % | 1.5 | 1.4 | 1.2 | 1.3 | 1.3 | 1.4 | 1.4 | 1.3 | 1.3 | 1.3 |
| SALT, % | 1.4 | 1.5 | 1.5 | 1.6 | 2.7 | 2.9 | 2.8 | 2.8 | 2.9 | 2.9 |
| OIL, % | 38 | 27 | 25 | 24 | 25 | 23 | 26 | 26 | 25 | 23 |
| ACCEPTABILITY (1 −> 9) | | | | | | | | | | |
| OVERALL | 6.82^{a} | 6.42^{a} | 6.07^{c} | 6.46^{a} | 6.36^{b} | 6.05^{c} | 6.58^{a} | 6.60^{a} | 6.43^{a} | 6.55^{a} |
| APPEARANCE | 6.56^{a} | 6.45^{a} | 6.06^{b} | 6.57^{a} | 6.18^{a} | 6.06^{b} | 6.44^{a} | 6.60^{a} | 6.39^{a} | 6.44^{a} |
| TEXTURE | 6.44^{a} | 6.39^{a} | 5.84^{b} | 6.33^{a} | 6.10^{a} | 5.86^{b} | 6.24^{a} | 6.44^{a} | 6.46^{a} | 6.26^{a} |
| CRISPNESS | 6.44^{a} | 6.56^{a} | 6.22^{b} | 6.46^{a} | 6.39^{a} | 6.31^{a} | 6.70^{a} | 6.57^{a} | 6.54^{a} | 6.73^{a} |
| FLAVOR | 6.70^{a} | 6.25^{a} | 5.92^{c} | 6.29^{a} | 6.15^{b} | 5.99^{c} | 6.56^{a} | 6.65^{a} | 6.49^{a} | 6.63^{a} |
| AFTERTASTE | 6.24^{a} | 5.83^{b} | 5.73^{d} | 6.13^{a} | 5.77^{c} | 5.73^{d} | 6.21^{a} | 6.30^{a} | 6.37^{a} | 6.32^{a} |
| COLOR (1 −> 5) | | | | | | | | | | |
| TOO LIGHT (1/2) | 88 | 36 | 23 | 47 | 26 | 33 | 29 | 31 | 44 | 40 |
| JUST RIGHT (3) | 11 | 34 | 33 | 28 | 27 | 35 | 37 | 43 | 32 | 29 |
| TOO DARK (4/5) | 1 | 30 | 44 | 25 | 47 | 31 | 34 | 27 | 24 | 31 |
| HARDNESS (1 −> 5) | | | | | | | | | | |
| TOO SOFT (1/2) | 29 | 13 | 15 | 16 | 12 | 16 | 14 | 21 | 16 | 19 |
| JUST RIGHT (3) | 60 | 52 | 41 | 48 | 44 | 44 | 45 | 50 | 53 | 56 |
| TOO HARD (4/5) | 11 | 35 | 44 | 36 | 44 | 41 | 41 | 29 | 31 | 25 |
| THICKNESS (1 −> 5) | | | | | | | | | | |
| TOO THIN (1/2) | 60 | 8 | 12 | 17 | 9 | 15 | 7 | 31 | 22 | 27 |
| JUST RIGHT (3) | 29 | 41 | 28 | 37 | 43 | 29 | 42 | 44 | 44 | 42 |
| TOO THICK (4/5) | 11 | 51 | 60 | 46 | 48 | 56 | 51 | 25 | 33 | 31 |
| SALT | | | | | | | | | | |
| TOO LITTLE (1/2) | 34 | 32 | 39 | 36 | 32 | 32 | 28 | 28 | 31 | 34 |
| JUST RIGHT (3) | 31 | 34 | 31 | 34 | 34 | 39 | 31 | 44 | 39 | 37 |
| TOO STRONG (4/5) | 35 | 33 | 30 | 30 | 33 | 29 | 42 | 29 | 31 | 29 |
| PURCHASE INTENT | 3.49 | 3.19 | 2.98 | 3.29 | 3.21 | 3.21 | 3.41 | 3.69 | 3.42 | 3.58 |

In samples 1-5 a thicker than the control chip slice was used to achieve a lower oil content, while varying exposure of chips to a brine solution and various de-oiler fan speeds. Samples 1-3 did not subject the potato slices to the brine solution whereas samples 4 and 5 washed the potato slices in a 3% brine solution for about 6 seconds. As used herein fan speed is defined as percent of maximum and refers to the fan speed of 32A and 32B as shown in FIG. 1. Although the thicker sliced potato resulted in moisture contents and oil contents within acceptable ranges, too many of the consumers indicated that the chip was too thick and too hard. Moreover, the flavor and purchase intent of these chips failed to measure up to the standard solicited by the control. Thus, the thicker chip sliced by itself does not appear to result in a reduced oil potato chip having desirable organoleptical properties.

Samples 6-9, on the other hand, appear to have achieved parity with the control sample. For example, in sample 6, a slice thickness of 0.068 inches was washed in a 3% brine solution. The chips were then sent to the de-oiler/dehydrating unit that was operating at fan 32A and 32B speeds of only 20% of normal. The Sample 6 operating parameters resulted in a potato chip having about 32% less oil than the control. In addition, the overall acceptability of the chip was similar to the control sample. Predictably, the thicker chip having an average slice thickness of about 0.068 inches, was rated by many consumers as too hard or too thick. Samples 7, 8, and 9 used a chip at a slice thickness of 0.058 inches washed in a 3% brine solution and sent to the de-oiler/dehydrating unit at varying fan speed intensities. Again, these chips appear to have parity with the organoleptical properties of the control chip as they relate to flavor, texture, crispness, appearance, after taste, and overall acceptability. Further, most of the consumers thought the hardness, thickness and salt intensity were just right.

While this invention has been particularly shown and described with preferred embodiment, it will be understood by those skilled in the art that various changes and form detail may be made therein without departing from the spirit and scope of the invention.

What is claimed is:

1. A method for producing a reduced oil potato chip, said method comprising the steps of:
a) providing a plurality of potato slices;
b) contacting said slices with an about 1% to about 6% brine solution for about 2 to about 20 seconds;
c) frying said slices in oil until said slices have a moisture content of about 3% to about 8% by weight thereby providing said slices with an oil content; and
d) lowering the oil content to less than 30% by weight and concurrently lowering the moisture content to between about 0.8% and about 2.0% by passing said slices through superheated steam having a temperature of from about 300° F. to about 340° F.

2. The method of claim 1, wherein said potato slices at step a) are between about 0.050 and about 0.083 inches in thickness.

3. The method of claim 1, wherein said potato slices at step a) consists of a cut geometry selected from the group consisting of a substantially flat geometry, a substantially ridged geometry, or a substantially wavy geometry.

4. The method of claim 1, wherein said brine solution at step b) comprises about 1.0% to about 4.5% NaCl solution.

5. The method of claim 1, wherein said contacting at step b) occurs by spraying.

6. The method of claim 1, wherein said contacting at step b) occurs in a process volume enabling full surface contact with said slices.

7. The method of claim 1, wherein the frying at step c) occurs at an initial temperature of about 320° F. to about 380° F. and a final temperature of about 280° F. to about 340° F.

8. The method of claim 1, wherein said slices after step c) comprise an oil content of between about 24% and 34% by weight.

9. The method of claim 1, wherein said lowering of said oil content at step d) occurs in an atmosphere having an oxygen content of between about 1% and about 4%.

10. The method of claim 1 wherein said oil content of said slices is between about 23% and about 30% by weight at step d).

11. A reduced oil potato chip made by the method of claim 1.

12. A reduced oil potato chip made by the method of:
a) slicing whole potatoes having a moisture content into a plurality of potato slices;
b) contacting said potato slices with an about 1% to about 6% brine solution;
c) frying said potato slices in oil until said slices have a moisture content of about 3% to about 8% by weight thereby providing said slices having an oil content; and
d) concurrently lowering said moisture content and said oil content of said slices, wherein said moisture content is between about 0.8% to about 2.0% by weight, and said oil content is less than about 30% by weight.

13. The method of claim 12, wherein said slicing at step a) results in a potato slice thickness between about 0.050 and about 0.083 inches.

14. The method of claim 12, wherein said potato slices at step a) consists of a cut geometry selected from the group consisting of a substantially flat geometry, a substantially ridged geometry, or a substantially wavy geometry.

15. The method of claim 12, wherein said brine solution at step b) comprises a solution having about 1.0% to about 4.5% NaCl by weight.

16. The method of claim 12, wherein said contacting at step b) occurs via a spray.

17. The method of claim 12, wherein said contacting at step b) occurs in a process volume enabling said brine solution to have full surface contact with said slices.

18. The method of claim 12, wherein said frying at step c) occurs an initial temperature of about 320° F. to about 380° F. and a final temperature of about 280° F. to about 340° F.

19. The method of claim 12, wherein said oil content of said slices that exit said fryer at step c) is between about 24% and 34% by weight.

20. The method of claim 12, wherein said unit at step d) comprises an atmosphere having an oxygen content of between about 1% and about 4%.

21. The method of claim 12 wherein said concurrent lowering of said oil content and said moisture content reduces said oil content to between about 23% and about 30% by weight.

22. A reduced oil potato chip made by the method of claim 12.
